(19) United States
(12) Patent Application Publication
(10) Pub. No.: US 2025/0366441 A1
(43) Pub. Date: Dec. 4, 2025

(54) Non-Slip and Protective Mat for Dog Car Seat Cover

(71) Applicant: Millena Schroder Rodrigues Neto, Winter Garden, FL (US)

(72) Inventor: Millena Schroder Rodrigues Neto, Winter Garden, FL (US)

(21) Appl. No.: 18/675,776

(22) Filed: May 28, 2024

(51) Int. Cl. A01K 1/035; B60N 2/60

(52) U.S. Cl. CPC A01K 1/0353; B60N 2/6018

(57) ABSTRACT

Disclosed in the present invention an anti-slip mat designed for dog car seat covers that addresses safety and comfort concerns during pet car travel. The mat is made of specialized materials like PP cotton and Twill fabric which enables the mat to offer a sturdy non-slip surface, complemented by Velcro, pressure button, Snap button or zippers for secure fastening. It provides a unique and effective solution for pet owners concerned about the safety and well-being of their four-legged companions during car journeys. In addition, the invention teaches of different methods of attaching the mat to the cover using zippers, pressure buttons, Velcro and stitching.

### TECHNICAL FIELD OF INVENTION

The present invention relates to products and accessories for pets, and more particularly to provision of a non-slip mat to cover dog car seat for safety and comfort daring car travels, wherein the product design elements have anti-slip materials of a variety of fabrics such as polypropylene (PP) cotton and Twill fabric material and methods of attaching the mat using automotive accessory fastening like zippers, buttons and Velcro.

### BACKGROUND OF THE INVENTION

There is the lack of safety and comfort for dogs during car rides, specifically when using dog car seat covers. The identified issue was that dogs would slip on the cover during turns and braking, which could cause discomfort and even pose a safety risk to the animal and the vehicle's occupants. The invention solves this problem by providing an anti-slip mat, made of specific material, that prevents the dog from slipping during the journey. Additionally, the robust fixation with zippers along the sides of the cover's base ensures stability and safety for the dog, regardless of its size.

The existing gaps in current technology that the proposed invention aims to address are related to the lack of specific and effective solutions to ensure the safety and comfort of dogs during car travel. Currently, dog seat covers may not provide an adequate non-slip surface, resulting in slips and discomfort for the animals during vehicle turns and stops. Additionally, inadequate fastening methods can lead to unwanted movements of the mat or seat cover, further compromising the safety of the animal.

There are a few prior art teachings about pet carrier in vehicles. For instance, the US patent number US20190233112A1 of 2019 by Boeing Co discloses a vehicle, ventilation system, and method for transporting pets. The said vehicle includes a passenger cabin, a monument, a pet travel system, and a ventilation system. The pet travel system includes at least a portion of the monument and at least one pet storage module configured to be received in the portion of the monument. The ventilation system includes an inlet port defined in the at least one pet storage module, an exhaust port defined in the at least one pet storage module, and an exhaust duct. The inlet port is in flow communication with an air source outside of the pet travel system. The exhaust duct is in flow communication with the exhaust port. The pressure within the exhaust duct is lower than the pressure of the air source to cause air to flow from the air source through the at least one pet storage module from the inlet port to the exhaust port.

However, the above prior art does not disclose features being taught in the present.

The proposed invention will fill these gaps by offering an anti-slip mat specifically designed to be used in conjunction with dog car seat covers. With specialized materials and a robust fastening design, the mat will ensure a stable and secure surface for the dog to settle on during the journey, minimizing the risk of slips and injuries.

There is need for a device to provide safety and comfort for dogs during car rides, specifically when using dog car seat covers.

### OBJECTS OF THE INVENTION

The main object of the present invention is to provide a mat is made of high quality, anti-slip material, providing secure support for the dog.

The other object is to provide a mat that is designed to be easily inserted and removed in our brand's standard car seat covers for dogs, ensuring compatibility and convenience.

Yet the other object is to avail a mat with a robust fastening that utilizes durable zippers on the sides of the cover's base to securely attach the mat, maintaining stability during travel.

The following summary is an explanation of some of the general inventive steps for the system, method, design and non-slip mat in the description.

### SUMMARY OF THE INVENTION

By way of summary, the present invention describes products and accessories for pets. The invention provides a non-slip mat to cover dog car seat for safety and comfort during car travels, wherein the product design elements have anti-slip materials of a variety of fabrics such as PP cotton and Twill fabric material and automotive accessory fastening like zippers, buttons and Velcro.

In one preferred embodiment, the present invention addresses safety and comfort concerns when traveling with dogs in cars, specifically focusing on the use of car seat covers for pets. The identified issue was the tendency for dogs to slip on these covers during turns and braking, posing risks of discomfort and potential accidents.

Specifically, the invention presents an anti-slip mat designed to fit seamlessly within our own brand's standard car seat covers for dogs (Pedigree Paw). The mat is crafted with specialized materials that enables the mat to provide an enhanced traction, preventing dogs of all sizes from slipping during car rides. The robust design ensures stability, even during sudden movements.

The key features of the invention include an anti-slip material that enables the mat to be of high-quality, anti-slip material, providing secure support for the dog. Another feature of the. invention a seamless integration in that the mat is designed to be easily inserted and removed in our brand's standard car seat covers for dogs, ensuring compatibility and convenience. The other equally important feature is its robust fastening in that the mat utilizes durable zippers on the sides of the cover's base to securely attach the mat, maintaining stability during travel.

By addressing these concerns, our invention enhances the safety and comfort of dogs during car journeys, providing peace of mind to pet owners and reducing the risk of accidents or injuries.

In addition, the invention teaches about different methods of attaching the mat to the cover using zippers, pressure buttons, Velcro and stitching.

The above summary is not an extensive overview of the invention and does not intend to limit the scope beyond what is described and claimed as a summary.

### BRIEF DESCRIPTION OF DRAWINGS

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the fabric non-slip mat when read in conjunction with the accompanying drawings.

FIG. 1 is the perspective of a non slip mat for dog car seat cover as described in the present invention.

FIG. 2 is the top view of the mat.

FIG. 3 is the bottom view of a non-slip mat for dog car seat cover.

FIG. 4 is the left side view of a non-slip mat for dog car seat cover.

FIG. 5 is the right side view of a non-slip mat for dog car seat cover.

FIG. 6 is the front view of a non-slip mat for dog car seat cover

FIG. 7 is the rear view of a non-slip mat for dog car seat cover.

FIG. 8 is the application view with the use of zipper of a non-slip mat for dog car seat cover.

FIG. 9 is the application view with the use of Velcro of a non-slip mat for dog car seat cover.

FIG. 10 is the application view with the use of Velcro from another direction of a non-slip mat for dog car seat cover.

FIG. 11 is the application view with the use of pressure button/snap button of a non-slip mat for dog car seat cover.

FIG. 12 is the application view with the use of pressure button/snap button from another direction of a non-slip mat for dog car seat cover.

FIG. 13 is the application view with the use of stickers of a non-slip mat for dog car seat cover.

The above figures describe the components in the accessory, their layout, and their location. The drawings identify the various parts and also the location of each compartment of the mat. The above drawings depict the complete standard accessory location sections. Customization of the mat to an equipment specific model is possible.

### DETAILED DESCRIPTION OF INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

In this description, the terms “comprising,” “including,” “containing,” “characterized by,” and grammatical equivalents thereof are inclusive or open-ended terms that do not exclude additional, un-recited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

The singular forms “a,” “an,” and “the” are intended to include the plural forms as well, unless the context clearly indicates otherwise.

The term “and/or” includes any and all combinations of one or more of the associated listed items. As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

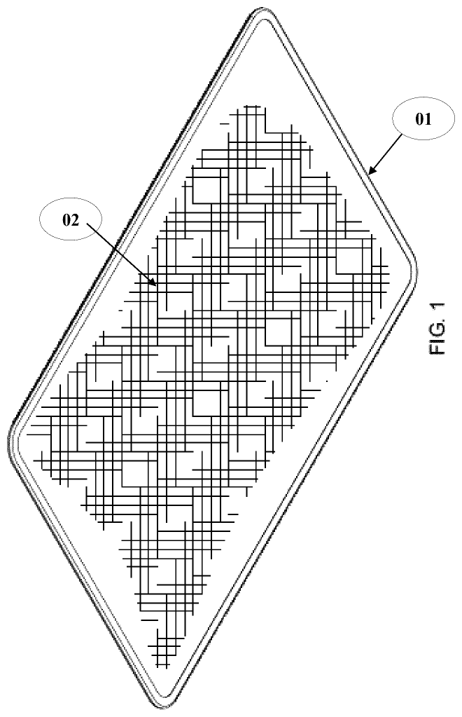

Turning to FIG. 1-FIG. 13, the invention provides products and accessories for pets. It provides a non-slip mat 01 for dog car seat cover for safety and comfort during car travels and comprises product design elements, anti-slip materials and automotive accessory fastening.

In one preferred embodiment, the present invention addresses safety and comfort concerns when traveling with dogs in cars, specifically focusing on the use of car seat covers for pets. The identified issue was the tendency for dogs to slip on these covers during turns and braking, posing risks of discomfort and potential accidents.

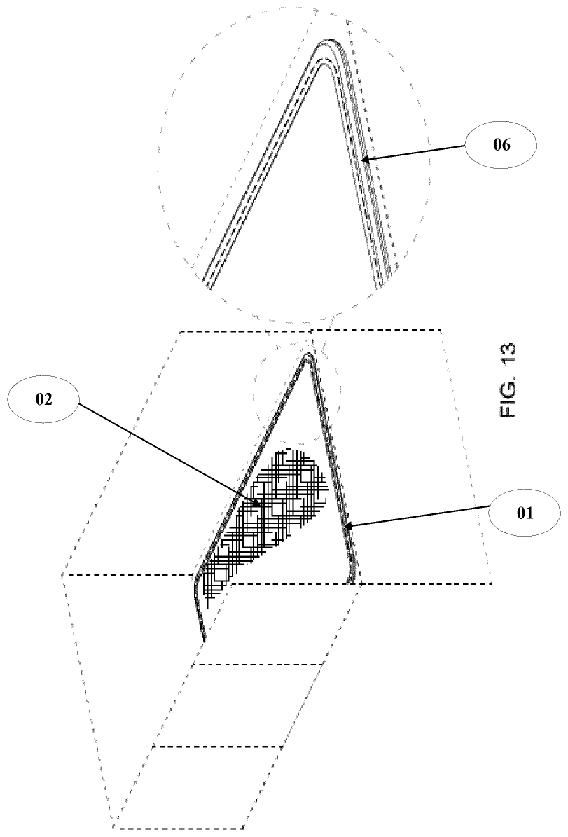

Specifically, the invention presents an anti-slip mat 01 designed to fit seamlessly within our own brand's standard car seat covers for dogs (Pedigree Paw) us in FIG. 1 and FIG. 13. The mat 01 is crafted with specialized materials that enables the mat to provide an enhanced traction, preventing dogs of all sizes from slipping during car rides: The robust design ensures stability, even during sudden movements.

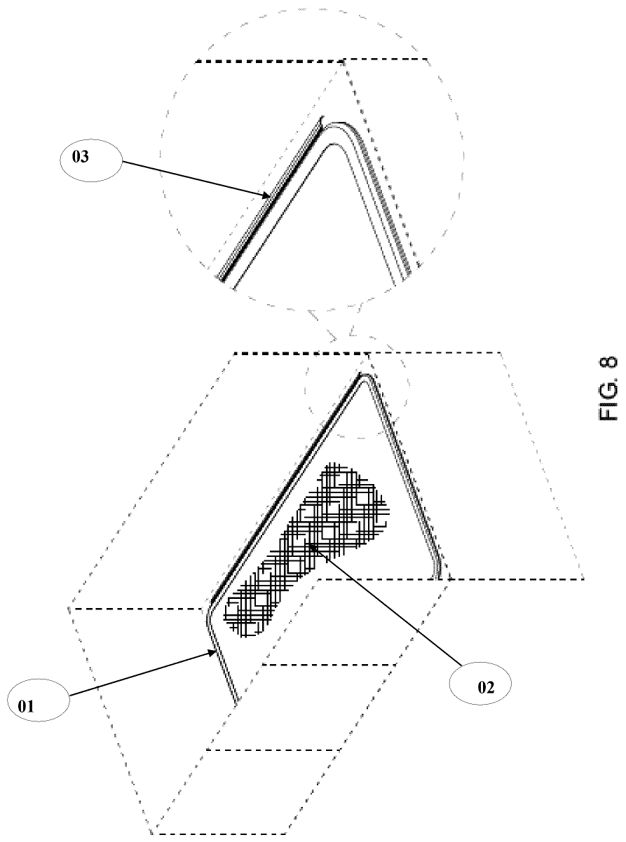

In FIG. 1, the key features of the invention include an anti-slip material 02 like twill fabric structure that enables the mat 01 to be of high quality, anti-slip material, providing secure support for the dog. Another feature of the invention a seamless integration in that the mat 01 is designed to be easily inserted and removed in our brand's standard car seat covers for dogs, ensuring compatibility and convenience. The other equally important feature is its robust fastening in that the mat utilizes durable zippers 03 on the sides of the cover's base to securely attach the mat 01, maintaining stability during travel according to FIG. 8.

### Components of the Invention

Anti-Slip Mat: The mat 01 is the main component of the invention. It is made of high-quality materials to provide non slip traction. The dimensions of the mat are 132×59 cm, allowing it to cover a substantial area of the car seat cover. The mat 01 is essential to ensure that the dog maintains a stable position during the car ride. 120GSM PP Cotton Material: This material is used as padding in the mat 01 to provide comfort to the animal.

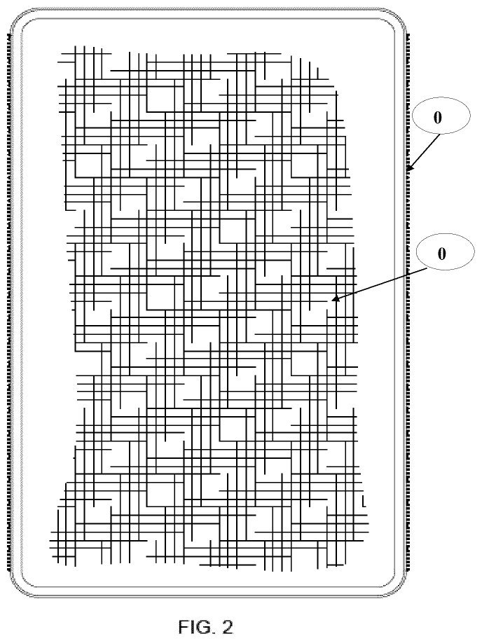

In FIG. 2, the polypropylene (PP) cotton fibers 02 is used for making the mat stiff and abrasive making them excellent scraper-type mats. It is soft and resilient, providing gentle support for the dog while sitting in the car. Polypropylene, in addition to being hardy, resists moisture, water damage, staining, pilling, and shedding making it an excellent value. Polypropylene fibers 02 clean very well and most staining is non existent.

600D Twill Fabric Material: This material is used as the outer layer of the mat. Twill fabric is durable, tear-resistant, and easy to clean. It provides a sturdy and resilient surface for the mat, ensuring its longevity and reliable performance over time

Zippers: The zippers 03 are used to secure the mat to the car seat cover as in FIG. 8. They are sturdy and durable, ensuring that the mat 01 remains firmly in place during the ride. The zippers allow for easy installation and removal of the mat, making it easy to clean and maintain the seat cover.

### Operation

The anti-slip mat 01 is designed to be easily inserted into the dog car seat cover. First, the mat is positioned in the desired area of the seat cover, covering the surface where the dog will sit. The zippers 03 along the sides of the mat 01 are then closed to securely fasten it to the seat cover. Once installed, the mat provides a non slip surface for the dog, ensuring that it remains safe and stable during the car ride as taught in FIG. 8 of the present.

### Benefits

Benefits of the invention comprises:
Provides safety and stability for the dog during car rides.
Offers comfort with PP cotton padding pattern 08 as seen in FIG. 1.
Resistant and durable mat, ensuring longevity and reliable performance.
Easy to install, remove, and clean, thanks to the zippers 83 of FIG. 8.

### Advantages of the Invention

The advantages of using our invention, the anti-slip mat 01 for dog car seat cover, are significant compared to traditional methods or other solutions available on the market.

Here are some of the distinct advantages.

Enhanced Safety: The anti-slip mat provides a stable surface for the dog during car rides, significantly reducing the risk of slips and falls. This helps prevent injuries to the animal and minimizes distractions for the driver.

Additional Comfort: With PP cotton padding 08, the mat 01 offers a more comfortable environment for the dog during the journey. This helps reduce the animal's stress and anxiety, making the travel experience more enjoyable for everyone involved.

Durability and Longevity: The use of high-quality materials, such as Twill fabric 09 and sturdy zippers 03, ensures that the mat 01 is resilient and long lasting over time as shown in FIG. 1 and FIG. 8. It can withstand frequent use and washing, maintaining its effectiveness and reliable performance for many years.

Ease of Use and Maintenance: Simple installation and removal, thanks to the zippers 03, make the anti-slip mat 01 easy to use. Additionally, its easy cleaning capability facilitates the maintenance and hygiene of the car seat cover, prolonging its lifespan.

The present invention provides products and accessories for pets. It provides a non-slip mat for dog car seat cover for safety and comfort during car travels and comprises product design elements, anti-slip materials and automotive accessory fastening. The anti-slip mat 01 for dog car seat cover, applies to the sector of pet products and accessories, specifically focusing on safety and comfort during car travel. It will attract customers to our invention are several distinct features such as enhanced safety wherein the customers will be drawn to our invention because it offers an effective solution to ensure the safety of their pets during car journeys.

By providing a non-slip surface, the mat helps prevent accidents and injuries, increasing pet owners' peace of mind. It offers an additional comfort to customers such as safety. Customers will value the comfort our invention provides to their pets. With PP cotton padding 08, the mat offers a cozy environment for the animal to relax during the trip, making the experience more enjoyable for both. The mat 01 is durable and reliable. The quality of materials used in our invention ensures durability and reliability.

Customers will be attracted to a product that not only meets their immediate needs but is also sturdy enough to withstand regular use and last for many years. The mat has a feature for ease of use and maintenance. The ease of installation, removal, and cleaning of the mat is another attractive point for customers. With sturdy zippers and easy to clean materials, our invention offers convenience and practicality for busy pet owners.

The invention provides a comprehensive and effective solution to ensure the safety, comfort, and convenience of dogs during car rides. By choosing our anti slip mat, pet owners can enjoy greater peace of mind and a more pleasant travel experience for their furry friends.

### BEST MODE OF CARRYING OUT THE INVENTION

The present invention describes an anti-slip mat 01 designed for dog car seat covers that addresses safety and comfort concerns during pet car travel The mat is made of specialized materials like PP cotton and Twill fabric which enables the mat to offer a sturdy non-slip surface, complemented by Velcro, pressure button, Snap button or zippers for secure fastening. It provides a unique and effective solution for pet owners concerned about the safety and well-being of their four-legged companions during car journeys.

The invention describes a non-slip mat that is attached to the cover. In addition to the rug having an anti slip function, the mat bas a protective function to the cover as well. In addition, they not only cover non-slip fabric 02 in the patent but also any type of fabric including cotton, nylon, polyester etc.

Further, the invention presents a novel method of fixing the mat is fixed to the cover. Originally the mat is fixed with zippers on the right and left sides. However, different ways of fixing the mat can be applied such as; pressure button, velvet and stitched on the cover itself as demonstrated in the drawings FIG. 1-FIG. 13.

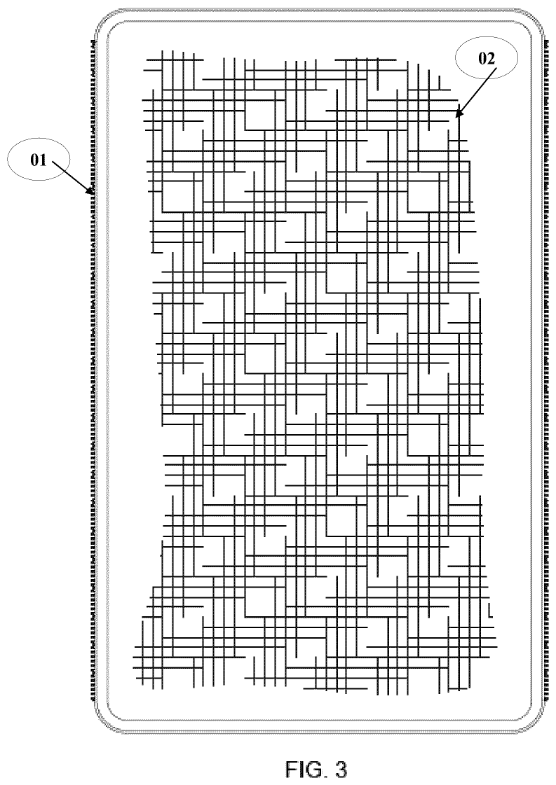

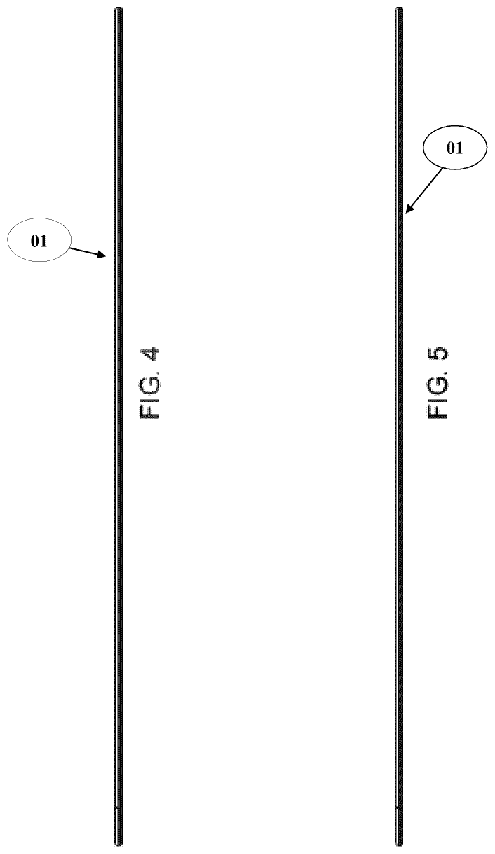

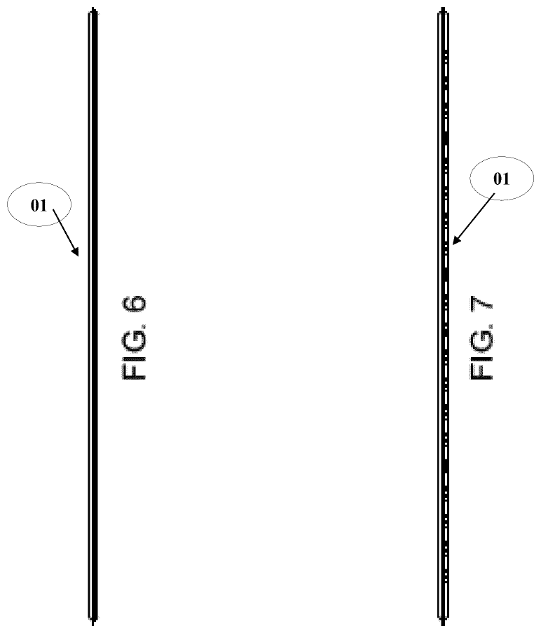

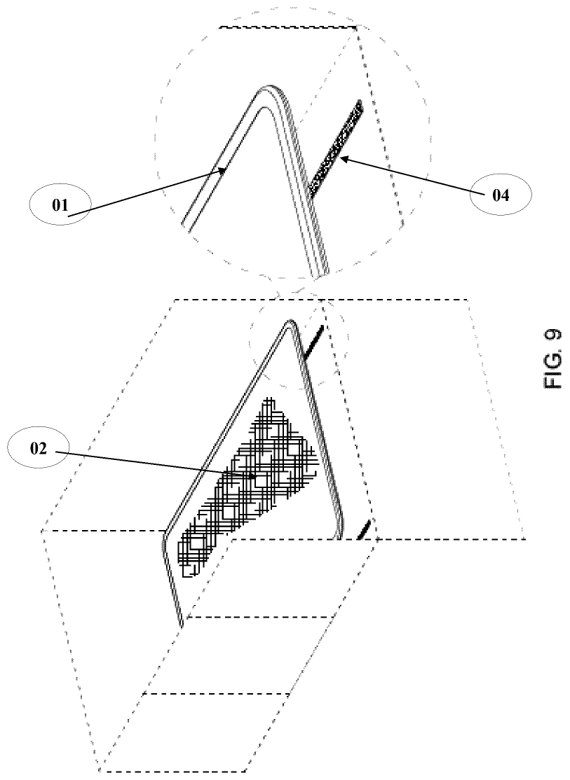

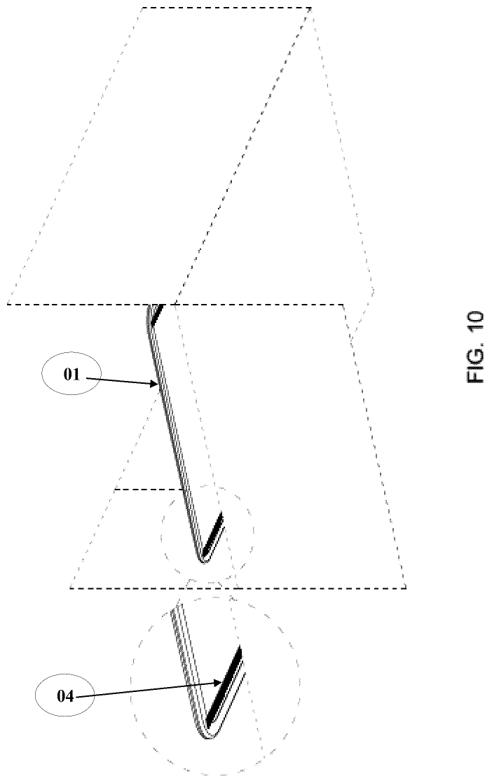

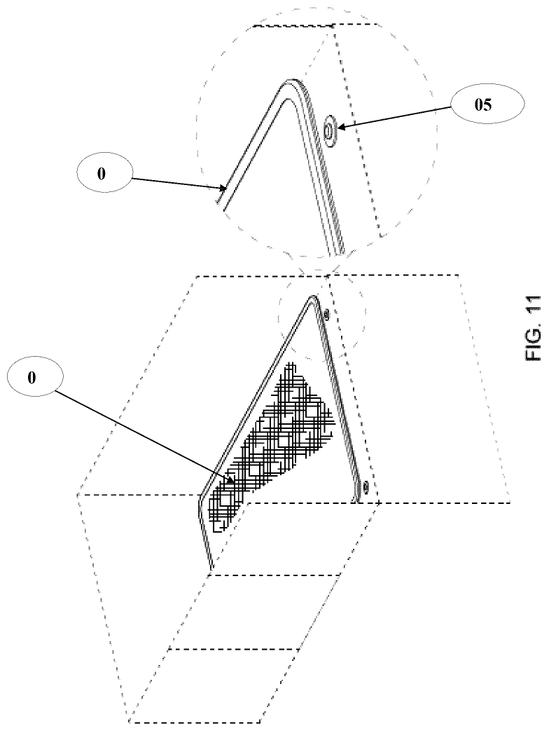

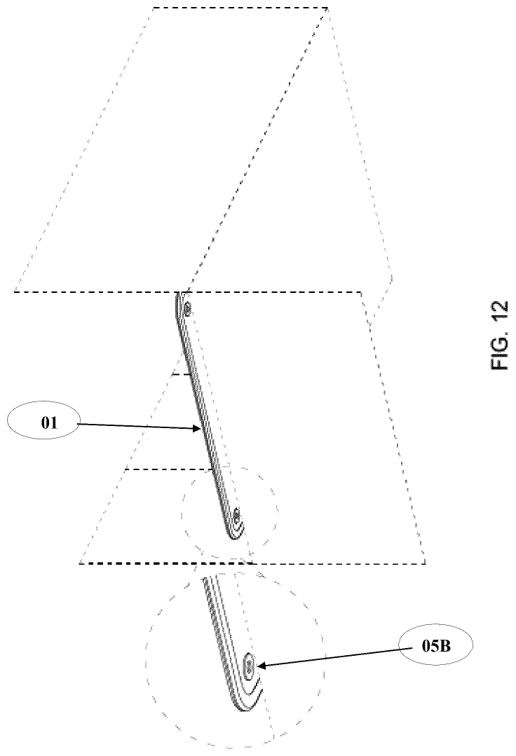

In one embodiment according to FIG. 1, the invention illustrates the perspective of a non-slip mat 01 for dog car seat cover as described in the present invention. In FIG. 2, it shows the top view of the mat 01 made a variety of material including Polypropylene (PP) cotton fibers padding 02. In FIG. 3, it demonstrates the bottom view. In FIG. 4, the invention is the left side view. FIG. 5 is the right side view. FIG. 6 is the front view. FIG. 7 is the rear view. FIG. 8 is the application view with the use of zipper 03. FIG. 9 is the application view with the use of Velcro 04. FIG. 10 is the application view with the use of Velcro 04 from another direction. FIG. 11 is the application view with the use of pressure button/snap button 05. FIG. 12 is the application view with the use of pressure button 05A or snap button 05B from another direction. FIG. 13 is the application view with the use of stickers 06.

Specifically, the invention comprises the following features:
a. The non-slip function of the mat,
b. The protective function of the cover,
c. The variety of fabrics that can be used.

In addition, the invention teaches about different methods of attaching the mat to the cover using zippers, pressure buttons, Velcro and stitching.

While the invention has been described with reference to numerous specific fabrics, one of ordinary knowledge in the field of making mats will recognize that the invention can be embodied in other specific forms without departing from the spirit of the invention. Specific stitching and operations may not be performed in one continuous series, and different specific methods may be performed in different embodiments. Furthermore, the processes or methods could be implemented using several sub-processes, or as part of an anti-slip process. Thus, one of ordinary knowledge in the field would understand that the invention is not to be limited by the foregoing illustrative details, but rather is to be defined by the appended claims.

### INDUSTRIAL APPLICATION

The present invention applies to pet industry. It provides products and accessories for pets. It provides a non-slip mat for dog car seat cover for safety and comfort during car travels and comprises product design elements, anti-slip materials and automotive accessory fastening. It will attract customers to our invention are several distinct features such as enhanced safety wherein the customers will be drawn to our invention because it offers an effective solution to ensure the safety of their pets daring car journeys. By providing a non slip surface, the mat helps prevent accidents and injuries, increasing pet owners' peace of mind. It offers an additional comfort to customers such as safety. Customers will value the comfort our invention provides to their pets. Overall, customers will be drawn to our invention because it offers a comprehensive and effective solution to enhance their pets' travel experience, providing safety, comfort, and convenience.

What is claimed is:

1. A non-slip mat for dog car seat cover for safety and comfort during car travels, comprising:
an anti slip mat with specialized anti-slip materials to provide non-slip function;
a variety of fabrics with protective function of the cover, and
automotive fastening accessories and stitching means.

2. The anti-slip mat as in claim 1, wherein the anti-slip mat is made of high-quality materials to provide non-slip traction with dimensions of the mat are 132×59 cm, allowing it to cover a substantial area of the car seat cover essential to ensure that the dog maintains a stable position during the car ride.

3. The anti-slip mat as in claim 2, wherein the specialized anti-slip material comprises polypropylene (PP) cotton which enables the mat to offer a sturdy non-slip surface.

4. The anti-slip mat as in claim 3, wherein the 120 GSM PP cotton material is used as padding in the mat to provide comfort to the animal, wherein the polypropylene (PP) cotton fibers is used for making the mat stiff and abrasive making them excellent scraper-type mats as it is soft and resilient, providing gentle support for the dog while sitting in the car, besides being hardy, resists moisture, water damage, staining, pilling, and shedding making it an excellent value, and easy to clean any staining on.

5. The anti-slip mat as in claim 2, wherein the specialized anti-slip materials comprises Twill fabric that enables the mat offer a sturdy non slip surface.

6. The anti-slip mat as in claim 5, wherein the 600D Twill fabric material is used as the outer layer of the mat as Twill fabric is durable, tear-resistant, and easy to clean and provides a sturdy and resilient surface for the mat, ensuring its longevity and reliable performance over time.

7. The anti-slip mat as in claim 1, wherein the automotive fastening accessories comprises zippers for secure fastening to the dog car seat cover.

8. The anti-slip mat as in claim 7, wherein the zippers are used to secure the mat to the car seat cover as they are sturdy and durable, ensuring that the mat remains firmly in place during the ride, and allow for easy installation and removal of the mat, making it easy to clean and maintain the seat cover.

9. The anti-slip mat as in claim 1, wherein the automotive fastening accessories comprise Velcro for attaching the mat to the dog car seat cover.

10. The anti-slip mat as in claim 1, wherein the automotive fastening accessories comprise a pressure button for attaching the mat to the dog car seat cover.

11. The anti-slip mat as in claim 1, wherein the automotive fastening accessories comprise a snap button for attaching the mat to the dog car seat cover.

12. The anti-slip mat as in claim 1, wherein the mat is attached to the dog car seat cover using stitching.

13. The anti-slip mat as in claims 1-2, wherein the mat provides a unique and effective solution for pet owners concerned about the safety and well-being of their four-legged companions during car journeys.

14. The anti-slip mat as in claim 13, wherein the mat is designed for dog car seat covers to address safety and comfort concerns during pet car travel.

15. A method of inserting the mat into the dog car seat cover, comprising steps of:
positioning the mat in the desired area of the seat cover, covering the surface where the dog will sit,
closing the zippers along the sides of the mat to securely fasten it to the seat cover, and
installing the mat to provide a non-slip surface for the dog, ensuring it remains safe and stable during the car ride.

16. The method as in claim 15, wherein the step of attaching the mat to the dog car seat cover:
using Zippers,
using pressure buttons;
using pressure buttons;
using Velcro, and
by stitching.
